(19) United States
(12) Patent Application Publication
(10) Pub. No.: US 2019/0112971 A1
(43) Pub. Date: Apr. 18, 2019

(54) HYBRID TURBOCHARGER SYSTEM AND METHOD

(71) Applicants: HYUNDAI MOTOR COMPANY, Seoul (KR); KIA MOTORS CORPORATION, Seoul (KR)

(72) Inventor: Justin FINK, South Lyon, MI (US)

(73) Assignees: HYUNDAI MOTOR COMPANY, Seoul (KR); KIA MOTORS CORPORATION, Seoul (KR)

(21) Appl. No.: 15/785,884

(22) Filed: Oct. 17, 2017

(51) Int. Cl. F02B 37/10; F02B 39/10; F02D 23/00; F16D 7/04; F16D 41/00; H02K 7/18

(52) U.S. Cl. CPC F02B 37/10; F02B 39/10; H02K 7/1823; F16D 7/04; F16D 41/00; F02D 23/00

(57) ABSTRACT

A turbocharger system and hybrid turbocharger, and a method of operating the same, are provided for a vehicle having an engine with an air intake and an exhaust. The hybrid turbocharger includes: a turbine having a turbine shaft, the turbine configured to receive gases from the exhaust and drive rotation of the turbine shaft; a compressor having a compressor shaft, the compressor configured to receive ambient air and supply compressed air to the air intake of the engine; a clutch connected to the turbine shaft and compressor shaft, the clutch configured to selectively engage the compressor shaft to the turbine shaft for rotation together; and a motor generator unit operably coupled to the compressor shaft. The system and hybrid turbocharger may also include a power controller operatively connected to the motor generator unit, and an electrical storage system operatively connected to the power controller.

### FIELD

The present disclosure relates to a hybrid turbocharger capable of functioning as a turbocharger, an electric supercharger, and a turbogenerator to improve engine performance.

### BACKGROUND

The statements in this section merely provide background information related to the present disclosure and may not constitute prior art.

Generally in vehicles, power generated by an engine depends on the amount of air and the amount of fuel introduced into a combustion chamber. In order to increase the power output of the engine, greater amounts of air and fuel can be supplied into the combustion chamber. For this, the size of the combustion chamber or total number of cylinders may be increased. However, the increased size of the combustion chamber or number of cylinders increases the weight and size of the engine. Different devices have been developed to provide increased air supply to boost engine performance or to increase the overall efficiency by harnessing the engine's exhaust energy, e.g. turbochargers, electric superchargers, and turbogenerators.

In a turbocharger, when exhaust gas rotates a turbine wheel of the turbocharger, a wheel of a coaxially-connected air compressor rotates along with the turbine wheel to supply compressed air into the combustion chamber, thereby increasing the power output of the engine. Similarly, in an electric supercharger, an integrated electrical machine is utilized to directly drive a compressor to supply compressed air into the combustion chamber. Unlike a turbocharger or supercharger, a turbogenerator utilizes exhaust flow through a turbine to drive a generator to produce electrical power. In this manner, these devices can capture waste energy from exhaust gas that is to be discarded, e.g. to generate electricity or to increase the power output of the engine, thereby achieving advantageous effects, such as improved fuel efficiency, the reduced size of the engine, the reduction of hazardous emissions, and the increased output power of the engine.

### SUMMARY

The present disclosure proposes a hybrid turbocharger device and system in which the compressor can be operated independently of the turbine, via an integrated motor generator unit, while permitting traditional turbocharger functionality by driving the compressor with power transmitted by the turbine via an integrated clutch mechanism, and also providing hybrid operation and power generation capability in an effort to increase engine power output and overall efficiency.

In one form of the present disclosure, a turbocharger system having a hybrid turbocharger for a vehicle having an engine with an air intake and an exhaust is provided, and includes: a turbine having a turbine shaft, the turbine configured to receive gases from the exhaust and drive rotation of the turbine shaft; a compressor having a compressor shaft, the compressor configured to receive ambient air and supply compressed air to the air intake of the engine; a clutch connected to the turbine shaft and compressor shaft, the clutch configured to selectively engage the compressor shaft to the turbine shaft for rotation together; and a motor generator unit operably coupled to the compressor shaft.

According to more detailed aspects, the motor generator unit is operable in a motor mode and a generator mode. The motor generator unit is configured to receive electrical energy and drive rotation of the compressor shaft in the motor mode, and the motor generator unit configured to be driven by the compressor shaft and supply electrical energy in the generator mode. The turbine shaft and compressor shaft are preferably coaxially disposed, and the compressor shaft may include a hollow shaft portion, the hollow shaft portion receiving an end of the turbine shaft. The motor generator unit includes a rotor and a stator, and the rotor is fixed to the compressor shaft for rotation therewith.

According to further aspects, the hybrid turbocharger is operable in a conventional turbo mode and an e-booster mode. The conventional turbo mode has the clutch engaged to rotatably connect the turbine shaft to the compressor shaft and has the motor generator unit not supplying or generating power. The e-booster mode has the clutch disengaged to disconnect the turbine shaft from the compressor shaft and has the motor generator unit energized to drive rotation of the compressor shaft, i.e. independently from the turbine. The hybrid turbocharger is further operable in a hybrid boost mode having the clutch engaged and the motor generator unit energized such that the compressor shaft is driven by both the turbine and the motor generation unit. Still further, the hybrid turbocharger is operable in a generation mode having the clutch engaged and the motor generation unit receiving energy from rotation of the compressor shaft via transmission of energy by the turbine rotated by engine exhaust.

The system and hybrid turbocharger may also include a power controller operatively connected to the motor generator unit. In the generation mode, the power controller operates the motor generator unit to receive a variable amount of energy from rotation of the compressor shaft, e.g. to control engine load shifting and ensure steady state operation. The system and hybrid turbocharger may also include an electrical storage system operatively connected to the power controller. The power controller receives information on a state of the electrical storage system and information on a state of the engine, and the power controller controls operation of the motor generator unit based on the state of the electrical storage system and the state of the vehicle. The power controller can be operatively connected to the clutch for engaging and disengaging the clutch, and the power controller operates the clutch and operates the motor generator unit based on the state of the electrical storage system and the state of the vehicle.

A method of operating a turbocharger system and hybrid turbocharger is also provided, and may include the steps of: providing a hybrid turbocharger such as described above; receiving information on a state of the engine and electrical storage system by the power controller; and operating the motor generator unit via the power controller based on the state of the electrical storage system and the state of the vehicle.

According to more detailed aspects, the power controller operates the motor generator unit in a plurality of modes including:

a conventional turbo mode having the clutch engaged to rotatably connect the turbine shaft to the compressor shaft and having the motor generator unit not supplying or generating power;

an e-booster mode having the clutch disengaged to disconnect the turbine shaft from the compressor shaft and having the motor generator unit energized to drive rotation of the compressor shaft;

a hybrid boost mode having the clutch engaged and the motor generator unit energized such that the compressor shaft is driven by both the turbine and the motor generation unit; and

a generation mode having the clutch engaged and the motor generation unit receiving energy from rotation of the compressor shaft.

The power controller may be configured to default to the conventional turbo mode. The power controller may be configured to operate the hybrid turbocharger in the conventional turbo mode when the state of the electrical storage system is high, and when the state of the engine is one of idle, steady state, decelerating and engine braking, or if the system experiences a fault or malfunction where uncontrolled operation is necessary. The power controller may also be configured to operate the hybrid turbocharger in the e-booster mode when the state of the electrical storage system is normal or high, and when the state of the engine is accelerating. The power controller may also be configured to operate the hybrid turbocharger in the hybrid boost mode when the state of the electrical storage system is normal or high, and when the state of the engine is sustained acceleration. The power controller may be configured to operate the hybrid turbocharger in the generation mode when the state of the electrical storage system is normal or low, and when the state of the engine is one of steady state, idle, deceleration and engine braking. The power controller may operate the hybrid turbocharger to extract less than all available energy from the motor generator when the state of the engine is steady state or idle. The power controller may also operate the hybrid turbocharger to apply engine load shifting.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a configuration view illustrating a turbocharger system and hybrid turbocharger according to an embodiment of the present disclosure;

FIG. 2 illustrates the hybrid turbocharger of FIG. 1;

FIG. 3 illustrates an enlarged view of the hybrid turbocharger of FIG. 2;

FIGS. 4-8 schematically depict operating modes of the turbocharger system and hybrid turbocharger of FIG. 1; and

FIG. 9 is a chart explaining a method of operating the turbocharger system and hybrid turbocharger of FIG. 1 according to the modes of FIGS. 4-8.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

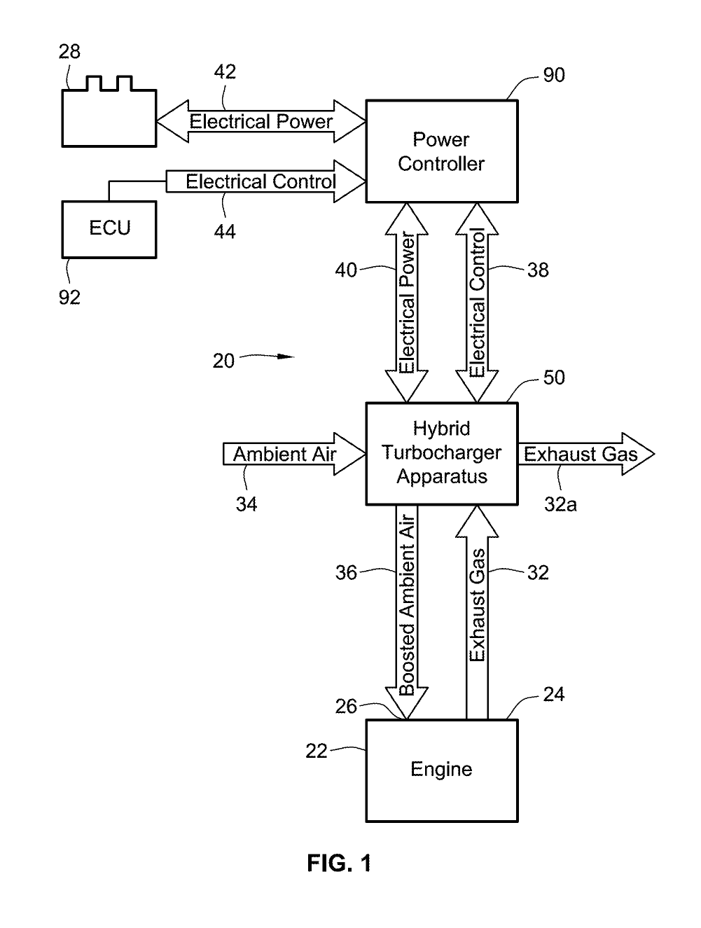

FIG. 1 schematically depicts a turbocharger system 20 for an engine 22 of a motor vehicle. The turbocharger system 20 generally includes a hybrid turbocharger 50 and a power controller 90 for controlling the hybrid turbocharger 50 and exchanging energy therewith. The engine 22 includes an exhaust 24 through which exhaust gas 32 is provided to the hybrid turbocharger 50 to extract energy therefrom. The engine 22 also includes an air intake 26, and the hybrid turbocharger 50 receives ambient air 34 which is boosted to provide compressed air 36 to the air intake 26 of the engine 22, as in a typical turbocharger.

The power controller 90 sends and receives data to/from the hybrid turbocharger 50 via a communications line 38. Similarly, electrical power is transferred between the controller 90 and hybrid turbocharger 50 via a power line 40. The power controller 90 can then share the electrical power via power line 42 with an electrical storage system 28 of the vehicle, such as a battery, capacitor or other known electrical power systems for vehicles, and/or with auxiliary devices requiring electrical power. The power controller 90 can also communicate with another controller via communications line 44, for example with an engine control unit, or other vehicle control unit. Alternatively, the power controller 90 can be incorporated into an engine control unit 92 or other vehicle control unit or computer system.

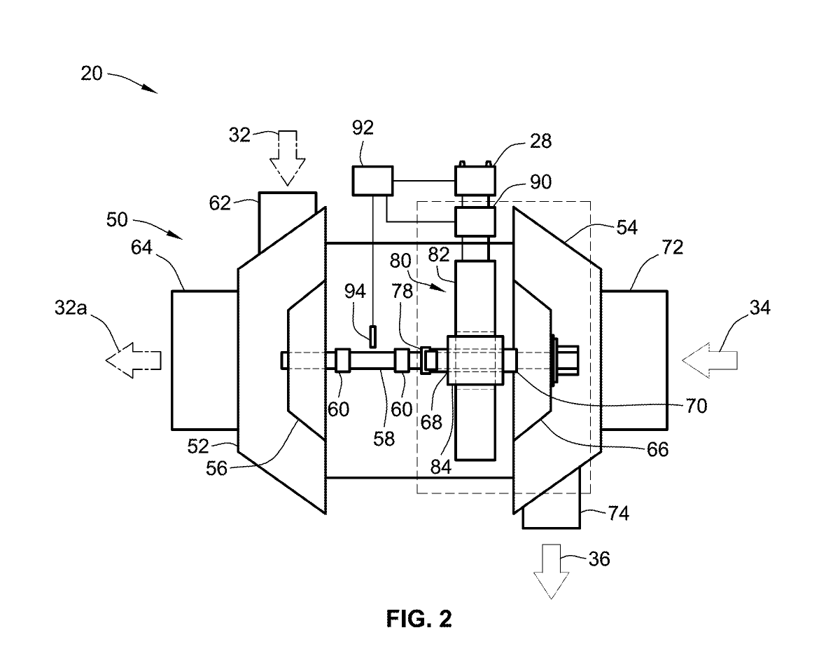

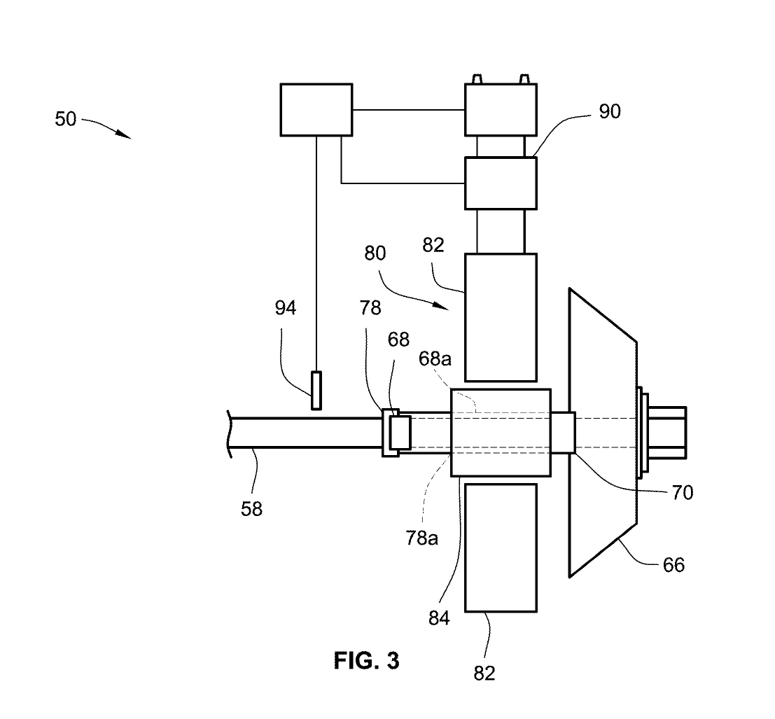

Turning to FIGS. 2 and 3, the hybrid turbocharger is shown in greater detail. The hybrid turbocharger 50 generally includes a turbine 52 operably connected to a compressor 54. The typical elements of turbines and compressors for turbochargers are well known and are not shown in the turbine 52 and compressor 54, but may be incorporated therein. The turbine 52 generally includes a turbine wheel 56 rotatably connected to a turbine shaft 58. The shaft 58 is supported by at least bearing 60 and is arranged in axial alignment with the compressor 54. The turbine 52 includes an inlet 62 receiving the engine exhaust gas 32, and the turbine 52 uses the exhaust gas 32 to rotate the wheel 56 and shaft 58. The exhaust gases are then expelled as indicated by arrow 32a via an outlet 64.

The compressor 54 includes an inlet 72 receiving ambient air 34, which is energized by the compressor 54 and ejected via outlet 74 as compressed air 36 provided to the engine 22. The compressor 54 includes a compressor wheel 66 rotatably connected to a compressor shaft 68. The compressor shaft 68 is supported by at least bearing 70 and is operatively connected to the turbine shaft 58. In this unique design, a clutch 78 is used to selectively connect the turbine shaft 58 to the compressor shaft 68. Any now known or hereinafter developed electrically-controllable clutch for rotatably connecting two shafts may be used as the clutch 78. Preferably, the clutch 78 is a mechanical, overrunning, one-way clutch mechanism structured to allow the compressor to automatically be driven by the turbine 52, or the motor generator unit 80 (discussed further below), or a combination of the two. Alternatively, the clutch 78 may be an electronically controllable clutch that is operated by the controller 90 (also discussed below). A speed sensor 94 may be incorporated to further aid in control of the hybrid turbocharger 50.

Preferably, the compressor shaft 68 includes a hollow portion 68a (i.e., has a tubular construction), that is sized to receive the turbine shaft 58 therein, either directly or through the clutch 78. Thus, the turbine shaft 58 may extend partially or fully through the compressor shaft 68 and also be supported by bearing 70, or just terminate within the clutch 78 which in turn extends into the hollow portion 68a formed at the free end of the compressor shaft 68, as best seen in FIG. 3. The tubular or hollow portion 68a of the compressor shaft 68, and the received portion 78 a of the turbine shaft 78 are shown in dotted lines in FIG. 3. The clutch 78 is preferably located in the area of the hollow portion 68a and at the juncture of the turbine shaft 58 and compressor shaft 68. The clutch 78 is electrically controllable for engagement or disengagement of the shafts 58, 68, e.g. by the power controller 90.

As also best seen in FIGS. 2 and 3, the compressor side of the hybrid turbocharger 50 also includes a motor generator unit 80 operably coupled to the compressor shaft 68. Any now known or hereinafter developed motor generator unit may be employed, and generally the unit 80 includes a stator 82 and a rotor 84. The rotor 84 is fitted on the compressor shaft 68 for rotation therewith, e.g. by splining, keying, bonding, welding, or other mechanical connections. Rotation of the compressor wheel 66 and compressor shaft 68 thus drives rotation of the rotor 84 relative to the stator 82 in the motor generator unit 80. Communication and/or power lines connect the motor generator unit 80 to the power controller 90, which in turn controls operation of the unit 80 and the transfer of electricity therebetween.

The motor generator unit 80 is itself operable in a motor mode and a generator mode. The motor generator unit 80 is configured to send and receive electrical energy from the power controller 90 (or other controller) via a battery or other component of the electrical supply system 28. In a motor mode, electrical energy is supplied to the motor generator unit 80 to drive rotation of the rotor 84, which in turn drives rotation of the compressor shaft 68, thereby providing for electrical operation of the compressor 54, independently from the turbine 50. In this mode, the clutch 78 would be overridden by the motor generator unit 80 (e.g., if a mechanical, one-way clutch mechanism), or the clutch could be disengaged by a controller (e.g. if an electronically controlled clutch). In a generator mode, the motor generator unit 80 can be operated to collect energy from the compressor 54 and its shaft 68 through interaction between the rotating rotor 84 and the stator 82 to supply electrical power 40 back through the power controller 90 (or other controller) and the electrical supply system 28.

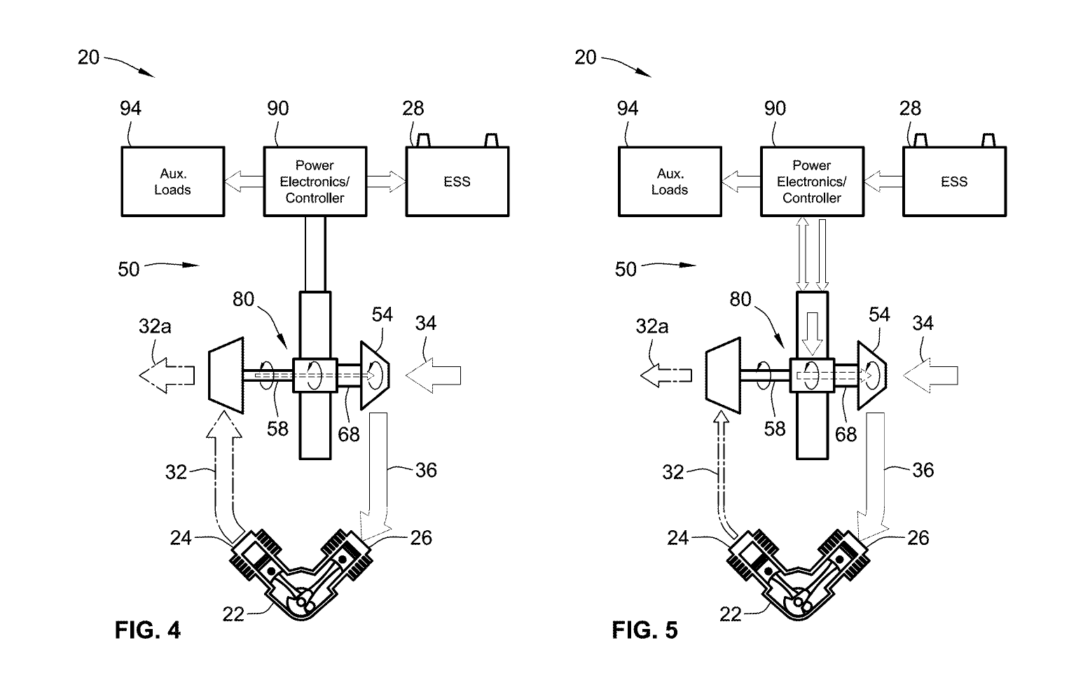

Additionally, it will be recognized that through operation of the clutch 78 in conjunction with operation of the motor generator unit 80, the turbocharger system 20 and the hybrid turbocharger 50 may be operated in many different modes. Turning to FIG. 4, a conventional turbo mode is depicted. In this mode, the clutch 78 is engaged such that the compressor shaft 68 rotates with the turbine shaft 58. In this mode, the compressor 54 is entirely powered by the turbine 52, and no electrical power is supplied or generated by the motor generator unit 80. In this way, the conventional use of the engine exhaust gas 32 to drive the turbine 52, and via shafts 58, 68 and clutch 78, drive the compressor 54 to compress ambient air 34 and provide the compressed air 36 to the air intake 26 of the engine 22.

Turning to FIG. 5, an electric booster mode (e-booster mode) is also possible with the hybrid turbocharger 50. In this mode, the clutch 78 is disengaged so that the turbine shaft 58 is decoupled from the compressor shaft 68. Accordingly, the engine exhaust gas 32 from the exhaust 24 of the engine 22 drives the turbine 52 and rotates the turbine shaft 58, but the shaft is freewheeling and the exhaust simply exits the turbine 52. In the e-booster mode, the power controller 90 supplies electrical power to the motor generator unit 80, which in turn drives rotation of the compressor shaft 68. The compressor 54 thus is capable of pressurizing the ambient air 34, independently from the turbine, to provide compressed air 36 to the air intake 26 of the engine 22 purely via electronic means.

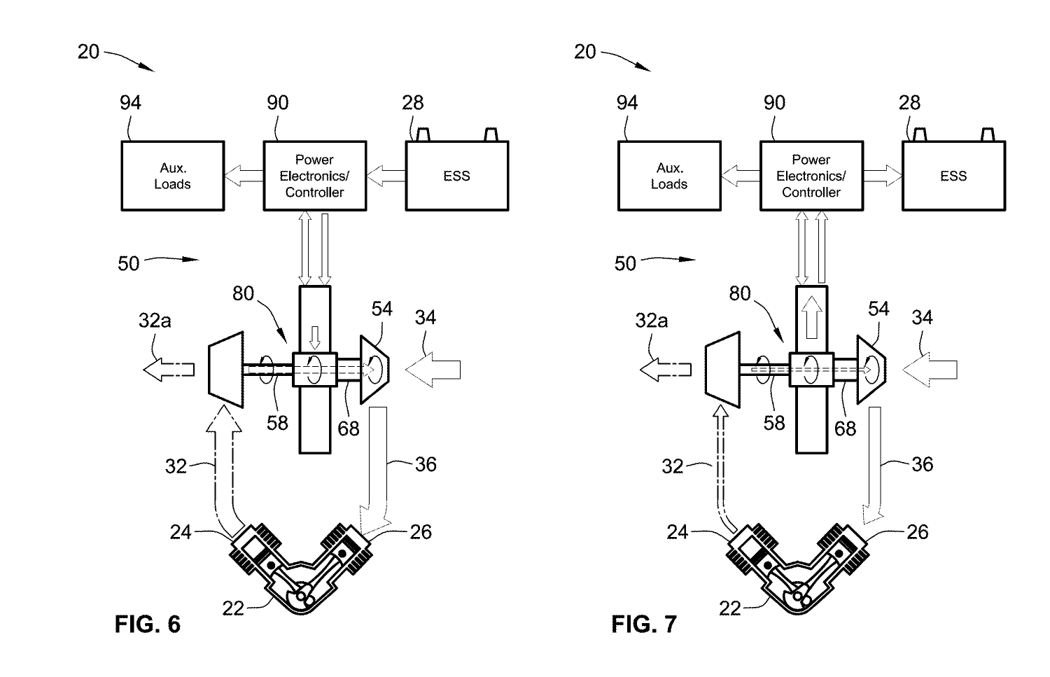

Turning now to FIG. 6, a hybrid boost mode of the turbocharger system 20 and hybrid turbocharger 50 is depicted. In this mode, the clutch 78 is engaged to rotatably connect the turbine shaft 58 and the compressor shaft 68. At the same time, the power controller 90 operates the motor generator unit 80 to further drive the compressor shaft 68 via electrical power. Accordingly, it can be seen that the mechanical and heat energy from the engine exhaust gas 32, as well as electric energy from the electrical storage system 28, can be used in tandem to drive the compressor 54 and provide compressed air 36 to the engine 22.

The turbocharger system 20 and hybrid turbocharger 50 can also be operated in a generation mode as depicted in FIG. 7. In this mode, the clutch 78 is again engaged to rotatably connect the turbine 52 and compressor 54 via the turbine shaft 58 and compressor shaft 68. Unlike the above-described modes, in this mode the power controller 90 operates the motor generator unit 80 to extract energy from the system. That is, rotation of the turbine shaft 58 and compressor shaft 68 also rotates the rotor 84, and the stator 82 can be used to extract electrical energy via the power line 40. A power controller 90 (or other controller) can supply the electricity to either the electric storage system 28 or directly to various auxiliary loads 94 within the vehicle. The power controller 90 can control the level of energy extraction to ensure that sufficient compressed air 36 is provided to the engine 22 in order to provide desired power output and response.

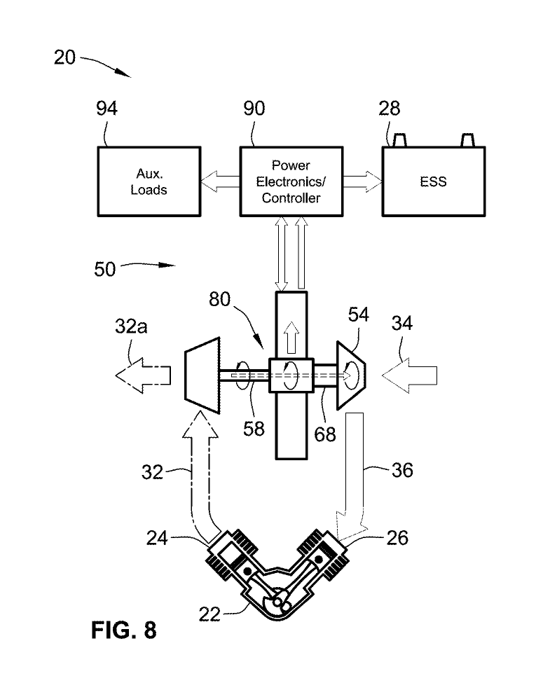

Similar to the generation mode in FIG. 7, FIG. 8 depicts a generation mode where the power controller 90 is actively controlling the power generation of the motor generator unit 80, and hence the load placed on the hybrid turbocharger 50 and the compression of air to the engine 22. In this way, the hybrid turbocharger 50 via the motor generator unit 80 can be utilized to apply engine load shifting, e.g. for obtaining optimum efficiency at steady state operation of the engine (e.g., constant speed highway cruising).

All of the aforementioned modes of the turbocharger system 20 and hybrid turbocharger 50 may be applied based on various vehicle conditions, such as a state of the electrical storage system and a state of the engine (or driving condition). The power controller 90 (or other controller) receives information on the state of the electrical storage system and the state of the engine (or other vehicle conditions) via the communications lines 44 with other control units such as the engine control unit 92, or through integration of control units or other networking (such as CAN).

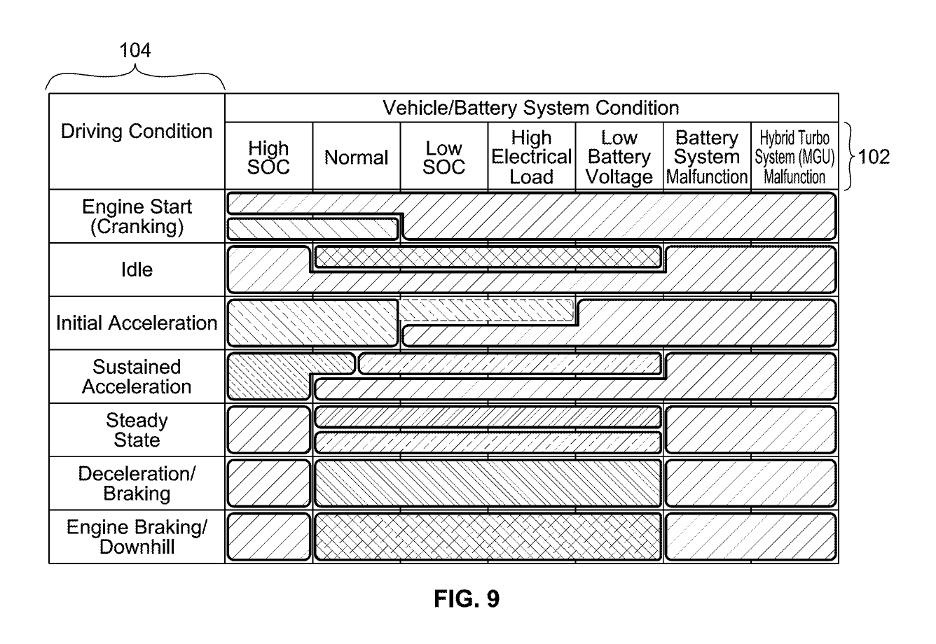

A summary of one system and method for operating the turbocharger system and hybrid turbocharger 50 is shown in FIG. 9. The state of the engine or driving condition is shown in the column designated 104, while the state of the electrical storage system (or battery or electrical load) is shown in the rows designated by reference numeral 102. For example, during engine start when the engine is cranking, the system 20 and turbocharger 50 may be operated in the convectional turbo mode. However, when the electrical storage system 28 has a normal or high state of charge, the e-booster mode may be utilized during engine crank to entirely drive the compressor 54 using electrical energy supplied to the motor generator unit 80. During engine start, the electrically operated compressor can be more efficient and responsive to quickly provide compressed air to the engine, e.g. when no exhaust energy is present or very low, thereby reducing pumping losses, increasing combustion chamber pressure and temperature, and aiding in more rapid combustion and startup of the engine.

As shown in the next row of FIG. 9, when the engine is idling, the hybrid turbocharger 50 may be operated in the conventional turbo mode. However, when the state of charge is normal to low, or there is high electrical load or low battery voltage, the hybrid turbocharger 50 may be operated in a generation mode to supply electrical power to the power controller 90 and electrical storage system 28, since the provision of compressed air to the engine is not in great demand during engine idling, and since the provision of compressed air to the engine is not in great demand during engine idling, any excess pressurized air could be bypassed and/or expelled from the system.

During initial acceleration of the vehicle, e.g. when engine torque is moderate to high, the hybrid turbocharger 50 may be operated in the e-booster mode to solely drive the compressor electrically via the motor generator unit 80. In this way, turbo-lag may be reduced or eliminated, and a near instant boost of pressure and the compressed air supplied to the engine can provide for better power and engine response. However, when the state of charge is low, there is high electrical load, the battery voltage is low, or there are other system malfunctions, the hybrid turbocharger 50 may be operated in the conventional turbo mode during initial acceleration.

During sustained acceleration of the engine and vehicle, the hybrid turbocharger 50 may be operated in the hybrid boost mode so that both the turbine 52 and the motor generator unit 80 can be utilized to drive the compressor 54, thereby providing better power and responsiveness to the engine 22 when the vehicle is undergoing an acceleration maneuver. At the same time, when the state of the electrical storage system or battery is such that more electricity is desired (i.e. the state of charges normal to low or there is high electrical load or low battery voltage), the system 20 and turbo charger 50 may be operated in a generation mode such that some energy is extracted via the motor generation unit 80.

Likewise, when the engine and vehicle is in a steady state operation (i.e. constant speed highway cruising), the generation mode may be set such that excess exhaust energy beyond the current booster requirement can be used for electrical power generation, or the power controller 90 can operate the motor generator unit 80 to apply engine mode shifting for optimum efficiency at the steady state. In this state of the engine and all remaining states of the engine, when the state of charge is high or the battery system or the motor generation unit is malfunctioning, the system 20 and turbocharger 50 may be operated in the conventional turbo mode.

Finally, as shown in the last two rows of FIG. 9, when the vehicle is decelerating or braking, or the engine is braking (e.g. during downhill driving), the system 20 and turbocharger 50 may be operated in a generation mode to capture waste energy from the exhaust to generate electrical power, e.g. during coasting or braking or downhill driving where excess energy is present for extraction.

Accordingly, by way of the unique turbocharger system 20 and hybrid turbocharger 50 of the present disclosure, the vehicle engine performance may be improved through the flexible operation of the compressor 54 in the hybrid turbocharger 50 in various modes based on the driving condition and/or the (state of the engine) or the state of the electrical supply system. The turbocharger system 20 and hybrid turbocharger 50 may be operated to compress ambient air using energy solely from the exhaust gas, solely from the electrical power system, or a hybrid using both energy sources. In this hybrid operation, the power controller can control the electrical power supplied to the motor generation unit to apply engine load shifting. Likewise, in situations where the turbocharger is producing excess energy, the present disclosure allows for capture of this excess energy as electricity and allows the electrical storage system to siphon additional energy when the state of charge is low or high electrical loads.

Although an embodiment of the present disclosure has been described for illustrative purposes, those skilled in the art will appreciate that various modifications, additions and substitutions are possible, without departing from the scope and spirit of the present disclosure as disclosed in the accompanying claims.

What is claimed is:

1. A hybrid turbocharger for a vehicle having an engine with an air intake and an exhaust, the hybrid turbocharger comprising:
a turbine having a turbine shaft, the turbine configured to receive gases from the exhaust and drive rotation of the turbine shaft;
a compressor having a compressor shaft, the compressor configured to receive ambient air and supply compressed air to the air intake of the engine;
a clutch connected to the turbine shaft and compressor shaft, the clutch configured to selectively engage the compressor shaft to the turbine shaft for rotation together; and
a motor generator unit operably coupled to the compressor shaft.

2. The hybrid turbocharger according to claim 1, wherein the motor generator unit is operable in a motor mode and a generator mode, the motor generator unit configured to receive electrical energy and drive rotation of the compressor shaft in the motor mode, the motor generator unit configured to be driven by the compressor shaft and supply electrical energy in the generator mode.

3. The hybrid turbocharger according to claim 1, wherein the turbine shaft and compressor shaft are coaxially disposed.

4. The hybrid turbocharger according to claim 3, wherein the compressor shaft includes a hollow shaft portion, the hollow shaft portion receiving an end of the turbine shaft.

5. The hybrid turbocharger according to claim 1, wherein the motor generator unit includes a rotor and a stator, the rotor being fixed to the compressor shaft for rotation therewith.

5. The hybrid turbocharger according to claim 1, wherein the hybrid turbocharger is operable in a conventional turbo mode and an e-booster mode, the conventional turbo mode having the clutch engaged to rotatably connect the turbine shaft to the compressor shaft and having the motor generator unit not supplying or generating power, the e-booster mode having the clutch disengaged to disconnect the turbine shaft from the compressor shaft and having the motor generator unit energized to drive rotation of the compressor shaft independent from the turbine.

6. The hybrid turbocharger according to claim 5, wherein the hybrid turbocharger is further operable in a hybrid boost mode having the clutch engaged and the motor generator unit energized such that both the compressor shaft is driven by both the turbine and the motor generation unit.

7. The hybrid turbocharger according to claim 6, wherein the hybrid turbocharger is further operable in a generation mode having the clutch engaged and the motor generation unit receiving energy from rotation of the compressor shaft.

8. The hybrid turbocharger according to claim 1, further comprising a power controller operatively connected to the motor generator unit, and wherein, in the generation mode, the power controller operates the motor generator unit to receive a variable amount of energy from rotation of the compressor shaft.

9. The hybrid turbocharger according to claim 8, further comprising an electrical storage system operatively connected to the power controller, and wherein the power controller receives information on a state of the electrical storage system, and wherein the power controller receives information on a state of the engine, and wherein the power controller controls operation of the motor generator unit based on the state of the electrical storage system and the state of the vehicle.

10. The hybrid turbocharger according to claim 9, wherein the power controller is operatively connected to the clutch for engaging and disengaging the clutch, and wherein the power controller operates the clutch and operates the motor generator unit based on the state of the electrical storage system and the state of the vehicle.

11. The hybrid turbocharger according to claim 1, wherein the clutch is a one-way, overrunning clutch mechanism.

12. A method of operating a hybrid turbocharger for a vehicle having an engine with an air intake and an exhaust, the method comprising:
providing a hybrid turbocharger comprising,
a turbine having a turbine shaft, the turbine configured to receive gases from the exhaust and drive rotation of the turbine shaft,
a compressor having a compressor shaft, the compressor configured to receive ambient air and supply compressed air to the air intake of the engine,
a clutch connected to the turbine shaft and compressor shaft, the clutch configured to selectively engage the compressor shaft to the turbine shaft for rotation together,
a motor generator unit operably coupled to the compressor shaft,
a power controller operatively connected to the motor generator unit, and
an electrical storage system operatively connected to the power controller;
receiving information on a state of the electrical storage system by the power controller;
receiving information on a state of the engine by the power controller; and
operating the motor generator unit via the power controller based on the state of the electrical storage system and the state of the vehicle

13. The method of operating a hybrid turbocharger according to claim 12, wherein the power controller operates the motor generator unit in a plurality of modes including,
a conventional turbo mode having the clutch engaged to rotatably connect the turbine shaft to the compressor shaft and having the motor generator unit not supplying or generating power,
an e-booster mode having the clutch disengaged to disconnect the turbine shaft from the compressor shaft and having the motor generator unit energized to drive rotation of the compressor shaft,
a hybrid boost mode having the clutch engaged and the motor generator unit energized such that both the compressor shaft is driven by both the turbine and the motor generation unit, and
a generation mode having the clutch engaged and the motor generation unit receiving energy from rotation of the compressor shaft.

14. The method of operating a hybrid turbocharger according to claim 13, wherein the power controller is configured to default to the conventional turbo mode.

15. The method of operating a hybrid turbocharger according to claim 13, wherein the power controller is configured to operate the hybrid turbocharger in the conventional turbo mode when the state of the electrical storage system is high, and when the state of the engine is one of idle, steady state, decelerating and engine braking.

16. The method of operating a hybrid turbocharger according to claim 13, wherein the power controller is configured to operate the hybrid turbocharger in the e-booster mode when the state of the electrical storage system is normal or high, and when the state of the engine is accelerating.

17. The method of operating a hybrid turbocharger according to claim 13, wherein the power controller is configured to operate the hybrid turbocharger in the hybrid boost mode when the state of the electrical storage system is normal or high, and when the state of the engine is sustained acceleration.

18. The method of operating a hybrid turbocharger according to claim 13, wherein the power controller is configured to operate the hybrid turbocharger in the generation mode when the state of the electrical storage system is normal or low, and when the state of the engine is one of steady state, idle, deceleration and engine braking.

19. The method of operating a hybrid turbocharger according to claim 18, wherein the power controller operates the hybrid turbocharger to extract less than all available energy from the motor generator when the state of the engine is steady state or idle.

20. The method of operating a hybrid turbocharger according to claim 18, wherein the power controller operates the hybrid turbocharger to apply engine load shifting.
